(19) United States
(12) Patent Application Publication
(10) Pub. No.: US 2008/0212540 A1
(43) Pub. Date: Sep. 4, 2008

(54) Frequency Scanning Method, Memory and Terminal to Implement the Method

(75) Inventors: Jerome Durand, Le Mans (FR); Jean Dumazy, Paris (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/068,000

(22) PCT Filed: Sep. 25, 2006
(86) PCT No.: PCT/IB06/53478

§ 371 Date: Mar. 25, 2008

(30) Foreign Application Priority Data
Sep. 29, 2005 (EP) 05300784.5
Sep. 25, 2006 (IB) PCT/IB2006/053478

(51) Int. Cl. H04Q 7/00; H04Q 7/32

(52) U.S. Cl. 370/335; 455/434

(57) ABSTRACT

A frequency scanning method to locate a carrier frequency of a base station in a CDMA (Code Division Multiple Access) communication system, the method comprising a cell detection step (76) to determine if a listening frequency is the carrier frequency of a base station by identifying a synchronization code within a radio signal received at the listening frequency, wherein after having located an initial carrier frequency, the cell detection step is only performed for listening frequencies that are spaced apart from the initial carrier frequency by an integer multiple of the channel spacing, this channel spacing being equal to the frequency bandwidth of spreading codes used by base stations in the CDMA communication system.

### FIELD OF THE INVENTION

The present invention relates to a frequency scanning method, a memory and a terminal to implement the method.

### BACKGROUND OF THE INVENTION

Frequency scanning methods are used in CDMA (Code Division Multiple Access) communication systems. Each CDMA communication system works within a predefined frequency space. Typically, the frequency space has a bandwidth W. For example, in WB-CDMA (Wideband-CDMA) systems, one of the bandwidths W is equal to 60 MHz. The frequency space can be continuous or not. Different CDMA communication systems implemented in different world regions have different frequency spaces. For example, the frequency space in Europe is different from the frequency space in the USA.

Cellular communication systems typically include a plurality of base stations. In CDMA communication systems, the base stations are differentiated by their frequency and scrambling code. In addition, neighboring base stations often utilize different carrier frequencies. One base station may use one or more carrier frequencies.

Carrier frequencies are also called “cell frequencies” or “center carrier frequencies”. In fact, a carrier frequency is in the middle of a base station bandwidth. The base station bandwidth corresponds to a channel spacing W_{c}. The term “channel spacing” is defined in CDMA standards such as standards 3GPP (third generation partnership project), document n^{o} 25.101. In short, the channel spacing W_{c} is equal to the bandwidth of spreading codes used by base stations in the CDMA system. In WB-CDMA systems, the channel spacing W_{c} is equal to 5 MHz, for example.

CDMA standards also define the minimum spacing Wᵣ, called “raster channel”, between two possible carrier frequencies. In WB-CDMA systems, the raster channel is equal to 200 kHz.

Periodically, mobile user equipment, such as a mobile terminal, needs to acquire a base station, for example when switching on or when travelling near the boundary of an already acquired base station. Acquisition begins by locating one or more carrier frequencies used by a base station. Subsequently, the scrambling code and its phase must be identified to communicate with any particular base station. Systems based on IS-95 (defined in the standard “TIA/EIA-95-B Mobile Station-Base Station Compatibility Standard for Dual-Mode Wideband Spread Spectrum Cellular System”) and their progeny use a common scrambling code. The base stations are differentiated by a unique offset in the common scrambling code. Systems such as WB-CDMA (defined by the 3GPP consortium) differentiate base stations with unique scrambling codes.

Various frequency scanning methods are known in the art for acquiring base stations at a given listening frequency. Acquisition time is a function of the time required to locate the carrier frequency of a base station as well as the time required to search and acquire the scrambling code of the base station.

It is desirable for a mobile terminal to acquire the scrambling code of base stations as rapidly as possible.

US 2003/0231605 in the name of Amarga et al. discloses frequency scanning methods to locate a carrier frequency of a base station. The existing methods have a cell detection step to determine if a listening frequency is the carrier frequency of a base station by identifying synchronization code within a radio signal received at the listening frequency.

The cell detection step is performed for listening frequencies that are spaced apart by 200 kHz. In some embodiments, once a carrier frequency has been detected, the method skips the frequencies that are within the base station bandwidth corresponding to the detected carrier frequency. However, even when skipping frequencies within the base station bandwidth, further frequencies are then scanned with a resolution of 200 kHz.

Scanning possible carrier frequencies with a resolution equal to the channel raster, i.e. 200 kHz, is a long process that should be minimized as much as possible to render base station acquisition faster.

US 2003/0231605 discloses other methods to minimize the time to scan the bandwidth W with a resolution of 200 kHz.

### SUMMARY OF THE INVENTION

Accordingly, it is an object of the invention to provide a faster frequency scanning method to locate a carrier frequency of a base station.

The invention provides a frequency scanning method wherein after having located an initial carrier frequency the cell detection step is only performed for listening frequencies that are spaced apart from the initial carrier frequency by an integer multiple of the channel spacing, this channel spacing being equal to the frequency bandwidth of spreading codes used by base stations in the CDMA communication system.

Therefore, contrary to the frequency scanning methods of US 2003/0231605, once an initial carrier frequency has been located, the frequency scan is only incremented in steps which are equal to the channel spacing. Thus, a scanning resolution equal to the channel raster is no longer used after detection of the initial carrier frequency. As a result, the number of steps necessary to scan the whole frequency space used by the CDMA communication system is reduced and the above method is faster than the methods of US 2003/0231605.

The embodiments of the above frequency scanning method may comprise one or several of the following features:

the cell detection step is not performed within a frequency range [Fₘᵢₙ; Fₘᵢₙ+W_{c}/2] and/or a frequency range [Fₘₐₓ−W_{c}/2; Fₘₐₓ], where:
Fₘᵢₙ is the smallest frequency of a frequency space allocated to the CDMA communication system,
Fₘₐₓ is the highest frequency of the frequency space,
W_{c} is the channel spacing;

at least the currently used carrier frequency is stored in a non-volatile memory upon switch-off of a mobile terminal, and, upon switch-on of the mobile terminal, the cell detection step is first carried out for a listening frequency that is equal to the stored frequency or spaced apart from the stored frequency by an integer multiple of the channel spacing.

The above embodiments of the frequency scanning method offer the following advantages:

skipping the frequency ranges [Fₘᵢₙ; Fₘᵢₙ+W_{c}/2] and [Fₘₐₓ−W_{c}/2; Fₘₐₓ] saves time and renders the frequency scanning method faster; and

using information on the carrier frequency used before switching off the mobile terminal saves time because it is likely that switch-off and switch-on of the mobile terminal occur in the same CDMA communication system.

The invention also relates to a terminal designed to scan the frequency for locating a carrier frequency of a base station in a wireless CDMA communication system, the terminal being able to perform a cell detection step to determine whether a listening frequency is the carrier frequency of a base station by identifying synchronization codes within a radio signal received at the listening frequency, wherein the terminal is designed to perform the cell detection step only for listening frequencies that are spaced apart from an initially located carrier frequency by an integer multiple of a channel spacing once the initially located carrier frequency has been located, the channel spacing being equal to the frequency bandwidth of spreading codes used by base stations in the CDMA communication system.

The embodiments of the above terminal may comprise one or several of the following features:

the terminal is designed to perform cell detection steps only within a frequency range [Fₘᵢₙ+W_{c}/2; Fₘₐₓ−W_{c}/2], where:
Fₘᵢₙ is the smallest frequency of a frequency space allocated to the CDMA communication system,
Fₘₐₓ is the highest frequency of the frequency space, and
W_{c} is the channel spacing.

the terminal is able to:
store a currently used carrier frequency in a non-volatile memory upon switch-off of the terminal, and
upon switch-on of the terminal, first carry out a cell detection step for a listening frequency that is equal to the stored frequency, or spaced apart from the stored frequency by an integer multiple of the channel spacing.

The invention also relates to a memory having instructions to execute the above frequency scanning method when the instructions are executed by an electronic calculator.

These and other aspects of the invention will be apparent form the following description, drawings and claims.

### BRIEF DESCRIPTION OF THE DRAWINGS

FIG. 1 is a schematic diagram of the structure of a part of a wireless CDMA communication system; and

FIG. 2 is a flowchart of a frequency scanning method to locate a carrier frequency of a base station of the system of FIG. 1.

### DESCRIPTION OF PREFERRED EMBODIMENTS

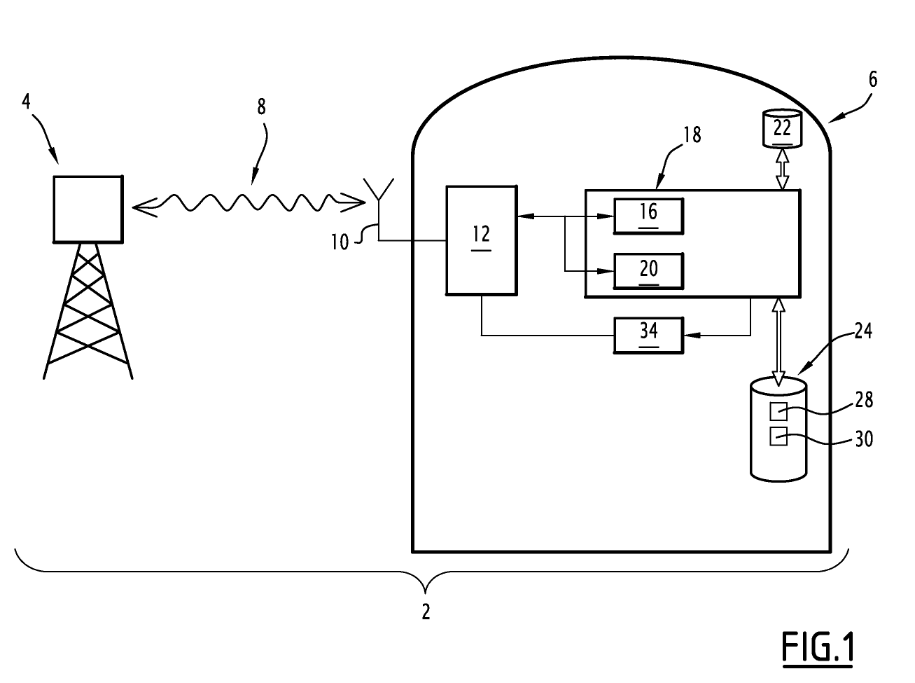

FIG. 1 shows a part of a wireless WB-CDMA communication system 2. For example, system 2 complies with UMTS (Universal Mobile Telecommunication System) standards.

FIG. 1 shows only the details necessary to understand the invention.

In the following description, the functions or constructions known to a person of ordinary skill in the art are not described in detail.

System 2 has many base stations and mobile terminals. For simplicity, only one base station 4 and one mobile terminal 6 are shown.

Base station 4 and terminal 6 communicate through wireless radio signal 8.

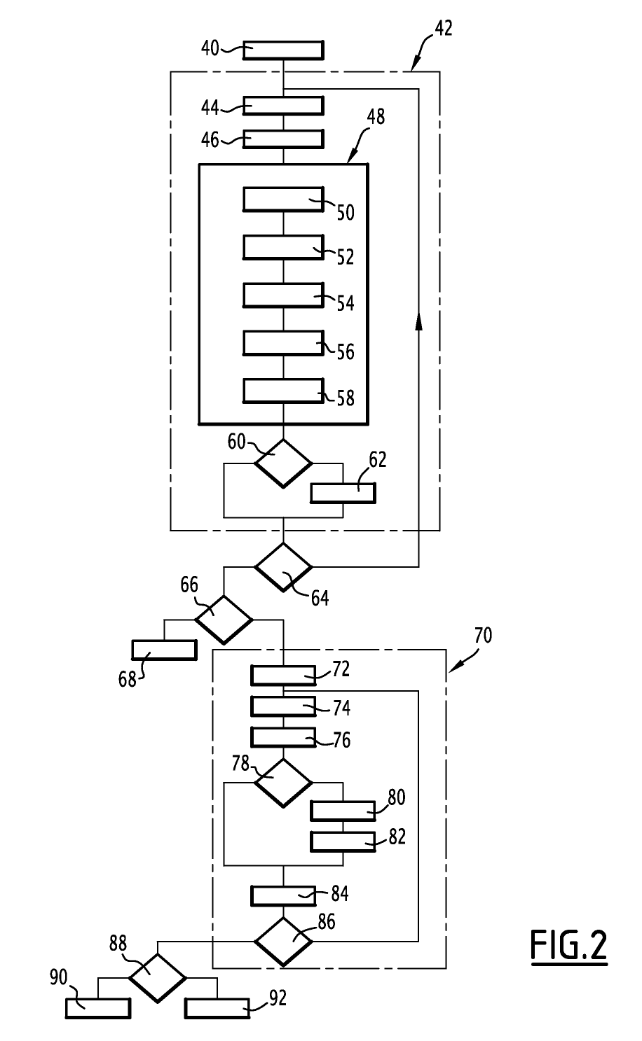

The embodiment of terminal 6 is similar to the one disclosed in FIG. 2 of US 2003/0231605, for example. Terminal 6 is a mobile phone, for example.

Briefly, terminal 6 has an antenna 10 to receive radio signal 8. Antenna 10 is connected to a tunable radio frequency down converter 12 that converts radio signal 8 down to a baseband signal.

Terminal 6 has a searcher 16 to detect scrambling codes and/or offsets in the baseband signal generated by converter 12.

A demodulator 20 receives samples from converter 12 and produces demodulated data.

Searcher 16 and demodulator 20 are implemented in a baseband processor 18.

Processor 18 is designed to implement the frequency scanning method of FIG. 2. For example, processor 18 contains a programmable electronic calculator that can execute instructions recorded in a memory 22. To this end, memory 22 records instructions to execute the method of FIG. 2.

Processor 18 is also connected to a non-volatile memory 24 that stores a list 28 of currently located carrier frequencies and a list 30 of CDMA system frequency spaces.

List 28 includes at least the currently used carrier frequency necessary to communicate with base station 4. List 28 may also include detected carrier frequencies of neighboring base stations.

List 30 includes a definition of the frequency space bandwidth W of each CDMA system wherein terminal 6 can work. For example, for each continuous frequency space list 30 stores the lowest frequency Fₘᵢₙ and the highest frequency Fmax of the frequency space. The frequency range [Fₘᵢₙ; Fₘₐₓ] is equal in width to bandwidth W for continuous frequency spaces. Bandwidth W is equal to 60 MHz, for example.

Other variables used by processor 18 can be stored in memory 24.

Processor 18 controls a tuner 34 which is able to tune the frequency generated by converter 12.

The operation of terminal 6 for acquiring the scrambling code of base station 4 will now be described with reference to FIG. 2.

Upon switch-off of terminal 6, in step 40, list 28 of the currently located carrier frequencies is stored in memory 24.

Subsequently, upon switch-on of terminal 6, a first scanning phase 42 is executed.

At the beginning of phase 42, in step 44, processor 18 chooses a frequency to listen to a first group of frequencies. The first group includes the currently used carrier frequency stored in list 28 as well as frequencies that are spaced apart from the stored currently used carrier frequency by an integer multiple of W_{c}. W_{c} is the channel spacing defined by standards relating to WB-CDMA systems.

Then, in step 46, tuner 34 tunes converter 12 to listen to the frequency chosen in step 44.

Subsequently, in step 48, terminal 6 detects if the listening frequency is a carrier frequency.

More precisely, in step 48, during an operation 50, converter 12 transforms radio signal 8 received at the listening frequency into a baseband signal. Then, in operation 52, searcher 16 correlates the baseband signal with a primary synchronization code. Primary synchronization codes are defined in standards relating to CDMA systems like UMTS standards. More precisely, this is known as P-SCH (Primary Synchronization Channel) detection in UMTS standards.

In operation 54, for example, the maximum peak in the correlation calculated in operation 52 is used to synchronize terminal 6 with base station 4.

Thereafter, in operation 56, the baseband signal is correlated with secondary synchronization codes. This is known as S-SCH (Secondary Synchronization Channel) detection in UMTS standards.

In operation 58, a primary scrambling code is detected. The primary scrambling codes (P-CPICH) are defined in the UMTS standards.

In step 60, if a primary scrambling code has been correctly detected in operation 58, this means that the listening frequency is a carrier frequency of a base station. Thus, in a step 62, the listening frequency is stored in list 28.

Otherwise, if no primary scrambling code has been detected, the method proceeds from step 60 directly to step 64 without executing step 62.

In step 64, processor 18 checks whether there are frequencies in the first group that have not yet been listened to. If there are, the method returns to step 44. Otherwise, the method proceeds to step 66.

In step 66, processor 18 checks whether list 28 is empty. If it is not, at least one carrier frequency has been located and the method stops in step 68.

Otherwise, this means that it is likely that terminal 6 has been switched off in a world region corresponding to a first CDMA communication system and switched on in another world region corresponding to a second CDMA communication system that used a frequency space different from the one of the first system.

In this situation, from step 66, terminal 6 proceeds to a second scanning phase 70.

At the beginning of phase 70, in step 72, a frequency F to be listened to is chosen and a variable step is set to Wᵣ, i.e. the raster channel. Frequency F to be listened to is chosen according to the following relation:

F=Fₘᵢₙ+W_{c}/2 (1)

where:

F is the frequency to be listened to,

Fₘᵢₙ is the lowest frequency of one of the frequency spaces defined in list 30.

W_{c} is the channel spacing.

In step 72, the definition of the chosen frequency space is different from the one used before switching off terminal 6.

Subsequently, in step 74, converter 12 is tuned to listening frequency F chosen in step 72.

Thereafter, in step 76, a cell detection step is carried out. For example, step 76 is identical with step 48.

At the end of step 76, in step 78 it is checked whether a primary scrambling code was correctly detected during step 76. If it was, in step 80, the frequency currently listened to is stored in list 28 and, in step 82, the variable step is set to 5 MHz, i.e. the channel spacing.

At the end of step 82 or if no primary scrambling code has been correctly detected, the frequency to be listened to is incremented by the value of the variable step in step 84.

In step 86 it is checked whether the incremented frequency to be listened to meets the following condition:

F≦Fₘₐₓ−W_{c}/2 (2)

where:

Fₘₐₓ is the highest frequency of the chosen frequency space; and

W_{c} is the channel spacing.

If relation (2) is met, the method returns to step 74.

Otherwise, the second scanning phase 70 ends.

Subsequently, in step 88, it is tested whether list 28 is still empty. If it is not, the method stops in step 90.

Otherwise, the method proceeds to a third scanning phase 92. During phase 92, the frequency space of the systems where terminal 6 was switched off is scanned similar to phase 70. Thus, phase 92 comprises the same steps as the ones defined with respect to phase 70 with the exception that during step 72, the chosen frequency space is the one corresponding to the place where terminal 6 was switched off.

Many additional embodiments are possible. For example, the method of FIG. 2 may be adapted to non-continuous frequency space. This means that the frequency space is formed from at least two non-adjacent sub-spaces W₁ and W₂. The definitions of frequency of sub-spaces W₁ and W₂ are stored in list 30, for example.

Many other methods can be used to locate the first carrier frequency. For example, the method disclosed in US 2003/0231605 can be used to this end.

It is also possible to scan the frequency space from the highest frequency Fₘₐₓ to the lowest frequency Fₘᵢₙ.

1. A frequency scanning method to locate a carrier frequency of a base station in a CDMA (Code Division Multiple Access) communication system, the method comprising a cell detection step to determine whether a listening frequency is the carrier frequency of a base station by identifying a synchronization code within a radio signal received at the listening frequency, wherein after having located an initial carrier frequency, the cell detection step is only performed for listening frequencies that are spaced apart from the initial carrier frequency by an integer multiple of the channel spacing, this channel spacing being equal to the frequency bandwidth of spreading codes used by base stations in the CDMA communication system.

2. The method according to claim 1, wherein the cell detection step is not performed within a frequency range [Fₘᵢₙ; Fₘᵢₙ+W_{c}/2] and/or a frequency range [Fₘₐₓ−W_{c}/2; Fₘₐₓ], where:
Fₘᵢₙ is the lowest frequency of a frequency space allocated to the CDMA communication system,
Fₘₐₓ is the highest frequency of the frequency space,
W_{c} is the channel spacing.

3. The method according to claim 1, wherein at least the currently used carrier frequency is stored in a non-volatile memory upon switch-off of a mobile terminal, and, upon switch-on of the mobile terminal, the cell detection step is first carried out for a listening frequency that is equal to the stored frequency or spaced apart from the stored frequency by an integer multiple of the channel spacing.

4. A memory containing instructions for the execution of a frequency scanning method according to claim 1, when the instructions are executed by an electronic calculator.

5. A terminal designed to frequency scan so as to locate a carrier frequency of a base station in a wireless CDMA communication system, the terminal being able to perform a cell detection step to determine whether a listening frequency is the carrier frequency of a base station by identifying synchronization codes within a radio signal received at the listening frequency, wherein the terminal is designed to perform the cell detection step only for listening frequencies that are spaced apart from an initially located carrier frequency by an integer multiple of a channel spacing once the initially located carrier frequency has been located, the channel spacing being equal to the frequency bandwidth of spreading codes used by base stations in the CDMA communication system.

6. Terminal according to claim 5, wherein the terminal is designed to perform cell detection steps only within a frequency range [Fₘᵢₙ+W_{c}/2; Fₘₐₓ−W_{c}/2], where:
Fₘᵢₙ is the lowest frequency of a frequency space allocated to the CDMA communication system,
Fₘₐₓ is the highest frequency of the frequency space, and
W_{c} is the channel spacing.

7. Terminal according to claim 5, wherein the terminal is able to:
store a currently used carrier frequency in a non-volatile memory upon switch-off of the terminal, and
upon switch-on of the terminal, first carry out a cell detection step for a listening frequency that is equal to the stored frequency, or spaced apart from the stored frequency by an integer multiple of the channel spacing.
